(19) United States
(12) Patent Application Publication
(10) Pub. No.: US 2013/0182371 A1
(43) Pub. Date: Jul. 18, 2013

(54) CAPACITOR AND METHOD OF MANUFACTURING THE SAME

(71) Applicant: Samsung Electro-Mechanics Co., Ltd., Suwon (KR)

(72) Inventors: Sang Kyun Lee, Gyeonggi-do (KR); Ji Sung Cho, Gyeonggi-do (KR); Bae-Kyun Kim, Gyeonggi-do (KR)

(73) Assignee: SAMSUNG ELECTRO-MECHANICS CO., LTD., Suwon (KR)

(21) Appl. No.: 13/723,741

(22) Filed: Dec. 21, 2012

(30) Foreign Application Priority Data
Dec. 22, 2011 (KR) 10-2011-0140408

(51) Int. Cl. H01G 4/30; H01G 13/00

(52) U.S. Cl. CPC H01G 4/30; H01G 13/00
USPC 361/301.4; 29/25.42

(57) ABSTRACT

Provided are a capacitor and a method of manufacturing the same. A first capacitor unit and a second capacitor unit are alternately stacked to three layers or more to form a stacked body, collector lead parts of the first capacitor units are connected to contact each other, collector lead parts of the second capacitor units are connected to contact each other, and the collector lead parts of the stacked body are stacked such that side surfaces thereof form a stepped shape.

### CROSS-REFERENCE TO RELATED APPLICATIONS

This application claims the benefit of Korean Patent Application No. 10-2011-0140408 filed with the Korea Intellectual Property Office on Dec. 22, 2011, the disclosure of which is incorporated herein by reference.

### BACKGROUND OF THE INVENTION

1. Field of the Invention

The present invention relates to a capacitor and a method of manufacturing the same.

2. Description of the Related Art

In recent times, as techniques in electric/electronic communication fields are developed, various mobile electronic products are being released, and a utilization range of an energy storage device such as a secondary battery is being widened.

In addition, as interests in environmental and resource problems are increased, competitions for developing techniques related to automobiles utilizing environment-friendly energy or production of environment-friendly energy such as solar power generation become intense.

A typical electric energy storage device, which is the most widely used up to now, is a secondary battery that can be used for a long time through charge/discharge. Since the secondary battery can maintain its output at a certain voltage for a relatively long time and a compact and lightweight structure thereof becomes possible, various secondary batteries are already widely used as power storage devices for small mobile devices.

Meanwhile, since the secondary battery has disadvantages such as relatively long time consumed for charge/discharge, a low output voltage of about 3V, short lifespan, and probability of explosion, its utilization fields are limited.

As an energy storage device that can compensate the above-mentioned disadvantages of the secondary battery, interests in a super capacitor in which a charge/discharge operation is performed by an electrochemical mechanism are being increased.

The super capacitor may be classified as various kinds such as an electric double-layer capacitor (EDCC), a hybrid capacitor, a pseudo capacitor, and so on, which can be instantly charged and have remarkably higher output characteristics than the secondary battery and remarkably longer lifespan than the secondary battery.

In consideration of the above-mentioned advantages, research on utilization for regenerative braking of automobiles is being continued.

Meanwhile, FIG. 1 is a view schematically showing a conventional capacitor.

Referring to FIG. 1, capacitor units each including electrodes 20 and 30, a collector 10, and a separating film 40 are continuously stacked. Here, the capacitor unit in which the electrode is a negative electrode and the capacitor in which the electrode is a positive electrode are alternately stacked.

In addition, a separate lead wire 50 is connected to the collector 10 to be connected to an external terminal (not shown).

Here, as shown in FIG. 1, since a method of coupling the separate lead wire 50 to the collector 10 requires a separate process of connecting the lead wire 50, its manufacturing efficiency may be lowered.

In order to solve the problem, a method of using a collector projecting from the outside of the collector as a lead part is disclosed in Patent Document 1.

FIGS. 2A and 2B are cross-sectional views schematically showing the method disclosed in Patent Document 1. Referring to FIGS. 2A and 2B, a collector 10′ projecting from one electrode contacts to be connected to another collector 10′ projecting from another electrode.

Here, when the projection collectors 10′ are connected to each other, while the projected collector 10′ disposed at a center of connection may almost not be bent, the projected collector 10′ far away from the center of connection may be abruptly belt to increase a degree of fatigue of the corresponding portion. As a result, the projected collector 10′ may be cut to reduce a capacity thereof or decrease reliability of the entire capacitor.

Such a problem is further intensified as the number of stacked electrodes is increased, and the problem becomes a large obstacle in implementation of a high output capacitor.

### RELATED ART DOCUMENT

### Patent Document

Patent Document 1: Korean Patent Laid-open Publication No. 10-2006-0002906

### SUMMARY OF THE INVENTION

The present invention has been invented in order to overcome the above-described problems and it is, therefore, an object of the present invention to provide a capacitor and a method of manufacturing the same that are capable of minimizing a degree of fatigue of collectors projecting to the outside of an electrode in electrically connecting the collectors.

In accordance with one aspect of the present invention to achieve the object, there is provided a capacitor formed by stacking a plurality of capacitor units in which a positive or negative electrode material is applied to one surface or both surfaces of a collector and a separating film is provided on an outer surface of the electrode material, including: a collector lead part projecting from the collector to the outside of the electrode material; a first capacitor unit including a positive electrode material; and a second capacitor unit including a negative electrode material, wherein the first capacitor unit and the second capacitor unit are alternately stacked to three layers or more to form a stacked body, collector lead parts of the first capacitor units are connected to contact each other, collector lead parts of the second capacitor units are connected to contact each other, and the collector lead parts of the stacked body are stacked such that projected side surfaces form a stepped shape.

Here, a width of the collector lead part in a direction projecting from the first capacitor unit may be the same as a width of the collector lead part in a direction projecting from the second capacitor unit.

In addition, the first capacitor unit or the second capacitor unit disposed at the uppermost layer of the stacked body may have a largest width, and a width of the second capacitor unit or the first capacitor unit may be sequentially reduced downward from the uppermost layer of the stacked body.

Further, the separating films of the first capacitor unit and the second capacitor unit may project to the outside of the positive electrode material or the negative electrode material.

In accordance with another aspect of the present invention to achieve the object, there is provided a capacitor formed by stacking a plurality of capacitor units in which a positive or negative electrode material is applied to one surface or both surfaces of a collector and a separating film is provided on an outer surface of the electrode material, including: a collector lead part projecting from the collector to the outside of the electrode material; a first capacitor unit including a positive electrode material; and a second capacitor unit including a negative electrode material, wherein a stacked body is constituted by a first stage capacitor unit, which is any one capacitor unit selected from the first capacitor unit or the second capacitor unit, second stage capacitor units stacked on both surfaces of the first stage capacitor unit and having a width smaller than that of the first stage capacitor unit, and third stage capacitor units stacked on outer surfaces of the second stage capacitor units and having a width smaller than that of the second stage capacitor units.

Here, the first stage capacitor unit and the third stage capacitor unit may include an electrode material having the same polarity, and the second stage capacitor unit and the first stage capacitor unit may include an electrode material having different polarities.

In addition, the collector lead parts of the third stage capacitor units may be bent toward the collector lead part of the first stage capacitor unit to electrically connect the collector lead parts.

Further, the collector lead parts of the second stage capacitor unit may be bent toward the first stage capacitor unit to be electrically connected to each other.

Furthermore, the stacked body may further include capacitor units having widths that are reduced in a direction far away from the outer surfaces of the third stage capacitor units.

In addition, the separating film of the capacitor unit may project to the outside of the electrode material.

In accordance with another aspect of the present invention to achieve the object, there is provided a capacitor formed by stacking a plurality of capacitor units in which a positive or negative electrode material is applied to one surface or both surfaces of a collector and a separating film is provided on an outer surface of the electrode material, including: a collector lead part projecting from the collector to the outside of the electrode material; a first capacitor unit including a positive electrode material; and a second capacitor unit including a negative electrode material, wherein a first stacked body unit cell is constituted by a first stage capacitor unit, which is any one capacitor unit selected from the first capacitor unit or the second capacitor unit, second stage capacitor units stacked on both surfaces of the first stage capacitor unit and having a width smaller than that of the first stage capacitor unit, and third stage capacitor units stacked on outer surfaces of the second stage capacitor units and having a width smaller than that of the second stage capacitor units, and a second stacked body unit cell is formed by the same manner as the first stacked body unit cell and coupled to the outer surface of the first stacked body unit cell.

Here, the first stage capacitor unit and the third stage capacitor unit may include an electrode material having the same polarity, and the second stage capacitor unit and the first stage capacitor unit may include an electrode material having different polarities.

In addition, the collector lead parts of the third stage capacitor units may be bent toward the collector lead part of the first stage capacitor unit to electrically connect the collector lead parts.

Further, the collector lead parts of the second stage capacitor unit may be bent toward the first stage capacitor unit to be electrically connected to each other.

Furthermore, the first stacked body unit cell may further include capacitor units having widths that are sequentially reduced in a direction far away from the outer surface of the third stage capacitor unit.

In accordance with another aspect of the present invention to achieve the object, there is provided a method of manufacturing a capacitor including a positive or negative electrode material, a separating film provided on an outer surface of the electrode material, a first capacitor unit in which the positive electrode material is coupled to one surface or both surfaces of a collector, a second capacitor unit in which the negative electrode material is coupled to one surface or both surfaces of a collector, and a collector lead part projecting from the collector to the outside of the electrode material, including: forming the first capacitor unit and the second capacitor unit; alternately stacking the first capacitor unit and second capacitor unit to three layers or more, wherein the collector lead parts are stacked in a stepped shape in a projecting direction; and bending and adhering the collector lead parts of the first capacitor units to contact each other, and bending and adhering the collector lead parts of the second capacitor units to contact each other.

Here, forming the first capacitor unit and the second capacitor unit may be performed such that a width of the collecting lead part in a direction projecting from the first capacitor unit is equal to a width of the collector lead part in a direction projecting from the second capacitor unit.

In addition, forming the first capacitor unit and the second capacitor unit may be performed such that a width of the collecting lead part in a direction projecting from the first capacitor unit is different from a width of the collector lead part in a direction projecting from the second capacitor unit.

In accordance with another aspect of the present invention to achieve the object, there is provided a method of manufacturing a capacitor including a positive or negative electrode material, a separating film provided on an outer surface of the electrode material, a first capacitor unit in which the positive electrode material is coupled to one surface or both surfaces of a collector, a second capacitor unit in which the negative electrode material is coupled to one surface or both surfaces of a collector, and a collector lead part projecting from the collector to the outside of the electrode material, including: forming capacitor units including the first capacitor units and the second capacitor units, wherein the capacitor units have different widths; stacking the capacitor units on one surface or both surfaces of the capacitor unit having a largest width in a sequence in which the widths are gradually reduced, wherein the first capacitor units and the second capacitor units are alternately stacked; and bending and adhering the collector lead parts of the first capacitor units to contact each other, and bending and adhering the collector lead parts of the second capacitor units to contact each other.

### BRIEF DESCRIPTION OF THE DRAWINGS

These and/or other aspects and advantages of the present general inventive concept will become apparent and more readily appreciated from the following description of the embodiments, taken in conjunction with the accompanying drawings of which:

FIG. 1 is a cross-sectional view schematically showing a conventional capacitor;

FIG. 2A is a cross-sectional view schematically showing problems of the conventional capacitor; and FIG. 2B is a cross-sectional view schematically showing problems of the conventional capacitor;

FIG. 3 is a cross-sectional view schematically showing a capacitor in accordance with an exemplary embodiment of the present invention;

FIG. 4 is a cross-sectional view schematically showing a capacitor in accordance with another exemplary embodiment of the present invention;

FIG. 5 is a cross-sectional view schematically showing a capacitor in accordance with still another exemplary embodiment of the present invention;

FIG. 6 is a flowchart schematically showing a method of manufacturing a capacitor in accordance with an exemplary embodiment of the present invention; and

FIG. 7 is a flowchart schematically showing a method of manufacturing a capacitor in accordance with another exemplary embodiment of the present invention.

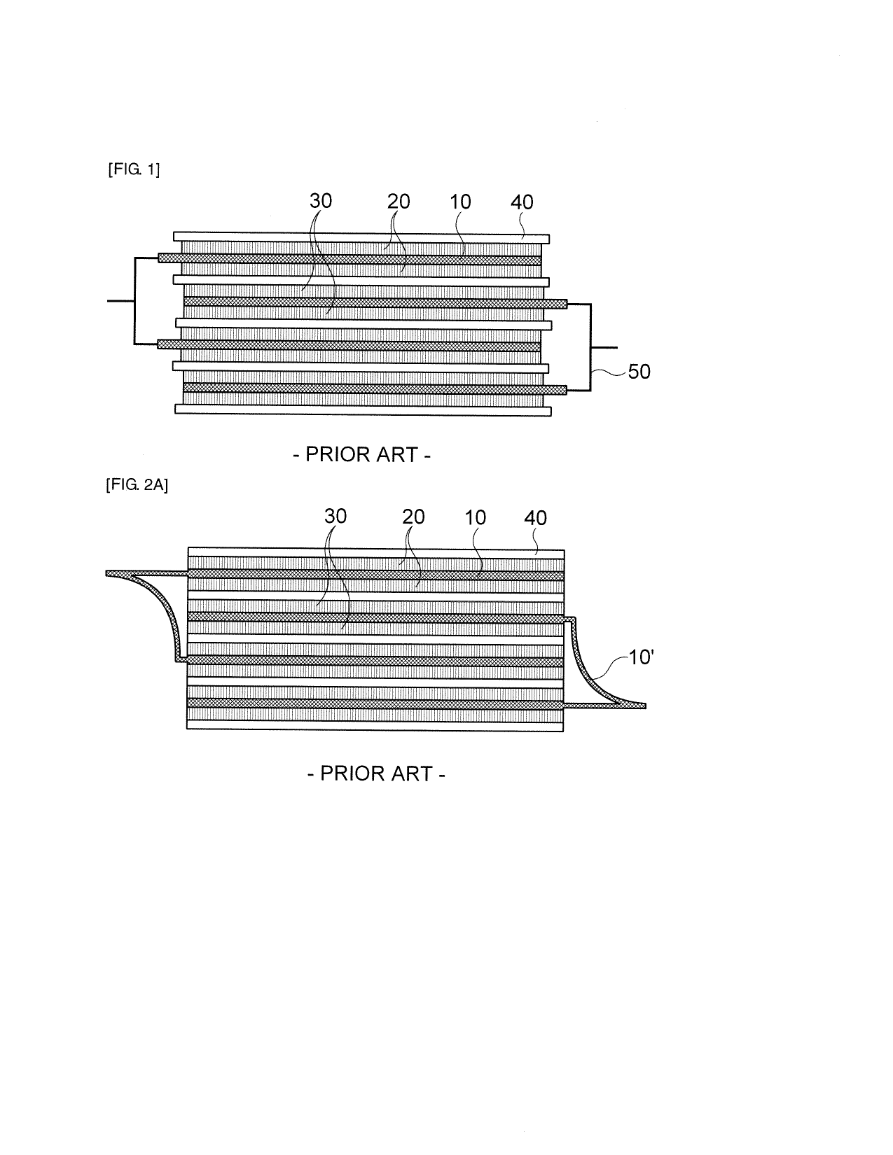

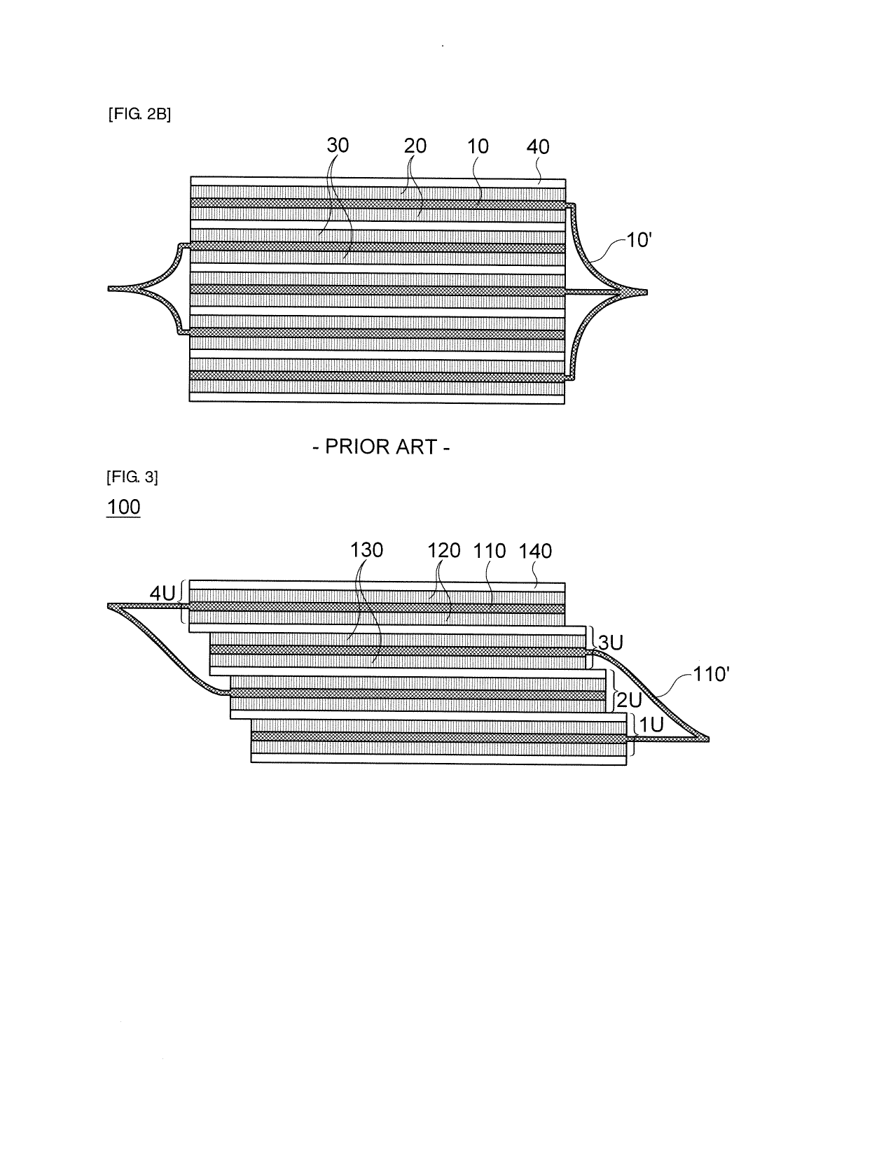

### DETAILED DESCRIPTION OF THE PREFERABLE EMBODIMENTS

Hereinafter, exemplary embodiments of the present invention will be described in detail. However, the present invention is not limited to the embodiments disclosed below but can be implemented in various forms. The following embodiments are described in order to enable those of ordinary skill in the art to embody and practice the present invention. To clearly describe the present invention, parts not relating to the description are omitted from the drawings. Like numerals refer to like elements throughout the description of the drawings.

Terms used herein are provided for explaining embodiments of the present invention, not limiting the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated components, motions, and/or devices, but do not preclude the presence or addition of one or more other components, motions, and/or devices thereof.

Hereinafter, configurations and operational effects of the present invention will be described in detail with reference to the accompanying drawings.

FIG. 3 is a cross-sectional view schematically showing a capacitor 100 in accordance with an exemplary embodiment of the present invention.

For the convenience of description, a unit in which a positive electrode material 120 is coupled to one surface or both surfaces of a collector 110 and a separating film 140 is disposed at an outer surface of the positive electrode material 120 is defined as a first capacitor unit 1U, a unit in which a negative electrode material 130 is coupled to one surface or both surfaces of the collector 110 and the separating film 140 is disposed at an outer surface of the negative electrode material 130 is defined as a second capacitor unit 2U, and the collector 110 projecting to the outside of the electrode material is defined as a collector lead part 110′.

Referring to FIG. 3, the capacitor 100 in accordance with an exemplary embodiment of the present invention may form a stacked body in which the first capacitor unit 1U and the second capacitor unit 2U are alternately stacked to three layers or more.

Here, the collector lead parts 110′ of the first capacitor units 1U and 3U are connected to contact each other, and the collector lead parts 110′ of the second capacitor units 2U and 4U are connected to contact each other.

While FIG. 3 shows that the collector lead part 110′ of the first capacitor units 1U and 3U and the collector lead part 110′ of the second capacitor units 2U and 4U are disposed in opposite directions, the units may be disposed in the same direction.

In addition, while FIG. 3 shows that the collector lead part 110′ of the first capacitor unit 1U disposed at the lowermost layer is not bent and the collector lead part 110′ of the first capacitor unit 3U disposed at the layer just above the lowermost layer is bent so that the two collector lead parts 110′ contact each other, the present invention is not limited thereto.

Further, while FIG. 3 shows the case in which four capacitor units 1U, 2U, 3U and 4U are stacked, it will be apparent that a larger number of capacitor units may be stacked.

As shown in FIG. 3, the four capacitor units 1U, 2U, 3U and 4U may have the same width. In this case, when one side of the units has a stepped shape, the other side also has a reversely-stepped shape.

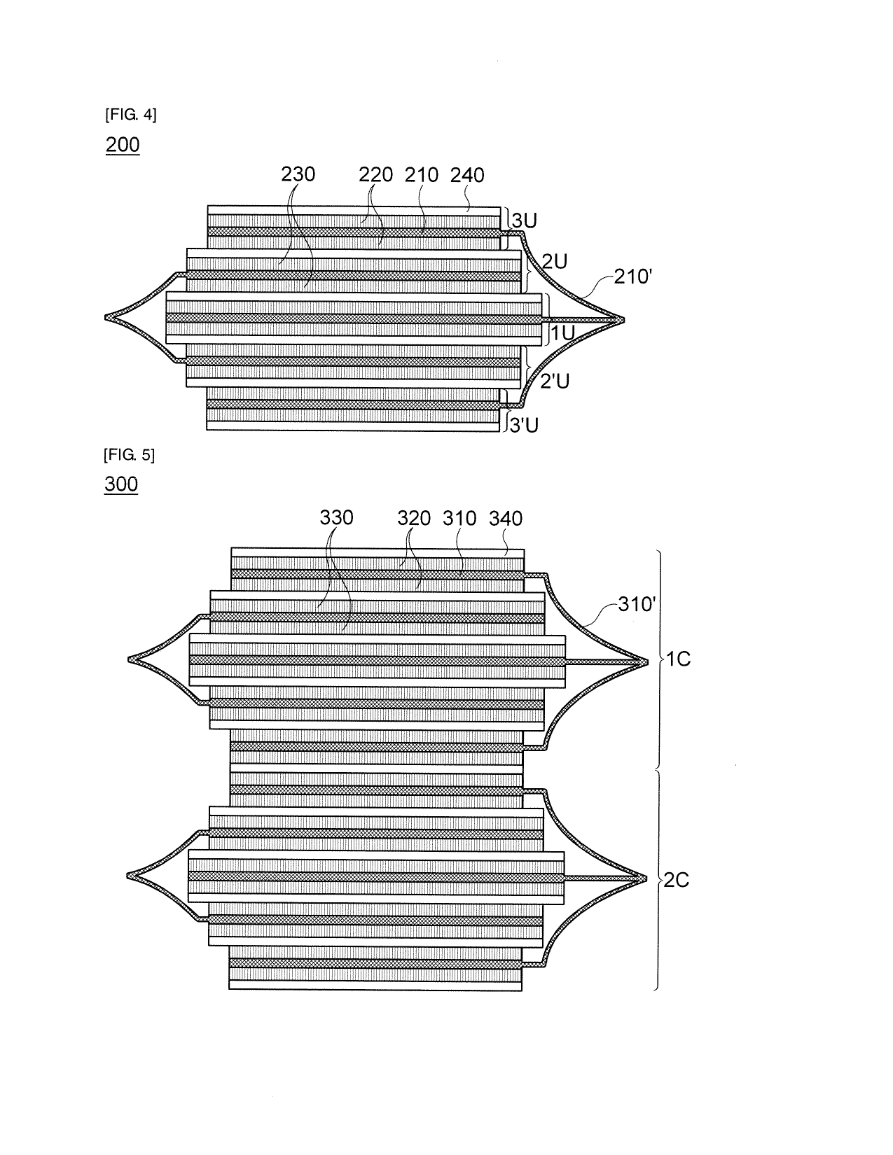

Furthermore, as shown in FIG. 4, the capacitor may be implemented by stacking the capacitor units 1U, 2U, 2′U, 3U and 3′U having different widths, the capacitor unit 1U disposed at the center layer and having a largest width, and the capacitor units 2U, 2′U, 3U and 3′U having widths that are sequentially reduced to both sides.

Meanwhile, while not shown, the separating film 140 may be exposed to the outside of the electrode material. In this case, the separating film 140 may function to support the collector lead part 110′ further improving reliability.

FIG. 4 is a cross-sectional view schematically showing a capacitor 200 in accordance with another exemplary embodiment of the present invention.

Referring to FIG. 4, the capacitor 200 in accordance with another exemplary embodiment of the present invention may include a stacked body constituted by a first stage capacitor unit 1U, second stage capacitor units 2U and 2′U stacked on both surfaces of the first stage capacitor unit 1U, and third stage capacitor units 3U and 3U′ stacked on outer surfaces of the second stage capacitors 2U and 2′U, respectively.

Here, the capacitor units U in contact with each other must have different polarities.

That is, the first stage capacitor unit U and the third stage capacitor units 3U and 3′U may include positive electrode materials 220, and the second stage capacitor units 2U and 2′U may include negative electrode materials 230.

Meanwhile, collector lead parts 210′ of the third stage capacitor units 3U and 3′U are bent toward a collector lead part 210′ of the first stage capacitor unit 1U to be connected to each other.

In addition, collector lead parts 210′ of the second stage capacitor units 2U and 2′U are bent toward the collector lead part 210′ of the first stage capacitor unit 1U to be connected to each other.

As described above, as the capacitor units 1U, 2U, 3U and 4U are stacked in a stepped shape, the collector lead parts 110′ are bent to a reduced angle to be electrically connected to each other, and thus, a degree of fatigue applied to the collector lead parts 110′ is also reduced in comparison with the conventional art.

FIG. 5 is a cross-sectional view schematically showing a capacitor 300 in accordance with still another exemplary embodiment of the present invention.

Referring to FIG. 5, it will be understood that the capacitor 300 in accordance with still another exemplary embodiment of the present invention is implemented by stacking at least two stacked bodies constituting the capacitor 200 shown in FIG. 4.

While FIG. 5 shows the capacitor 300 in which ten capacitor units 1U, 2U, 2′U, 3U and 3′U are stacked, it will be appreciated that the capacitor units may be continuously stacked. However, when the capacitor units are continuously stacked, since a width of the capacitor unit disposed at the outermost layer may be excessively reduced, a capacity of the capacitor 300 may not be largely increased. In addition, while the degree of fatigue of the collector lead part 310′ may be reduced by a stepped stacking method, as the collector lead part 310′ is far away from a center thereof, a bending angle of the collector lead part 310′ may be gradually increased.

Accordingly, as shown in FIG. 5, an appropriate number of capacitor units may be stacked to form a plurality of stacked bodies, and then, the stacked bodies may be coupled to increase the capacity of the capacitor 300.

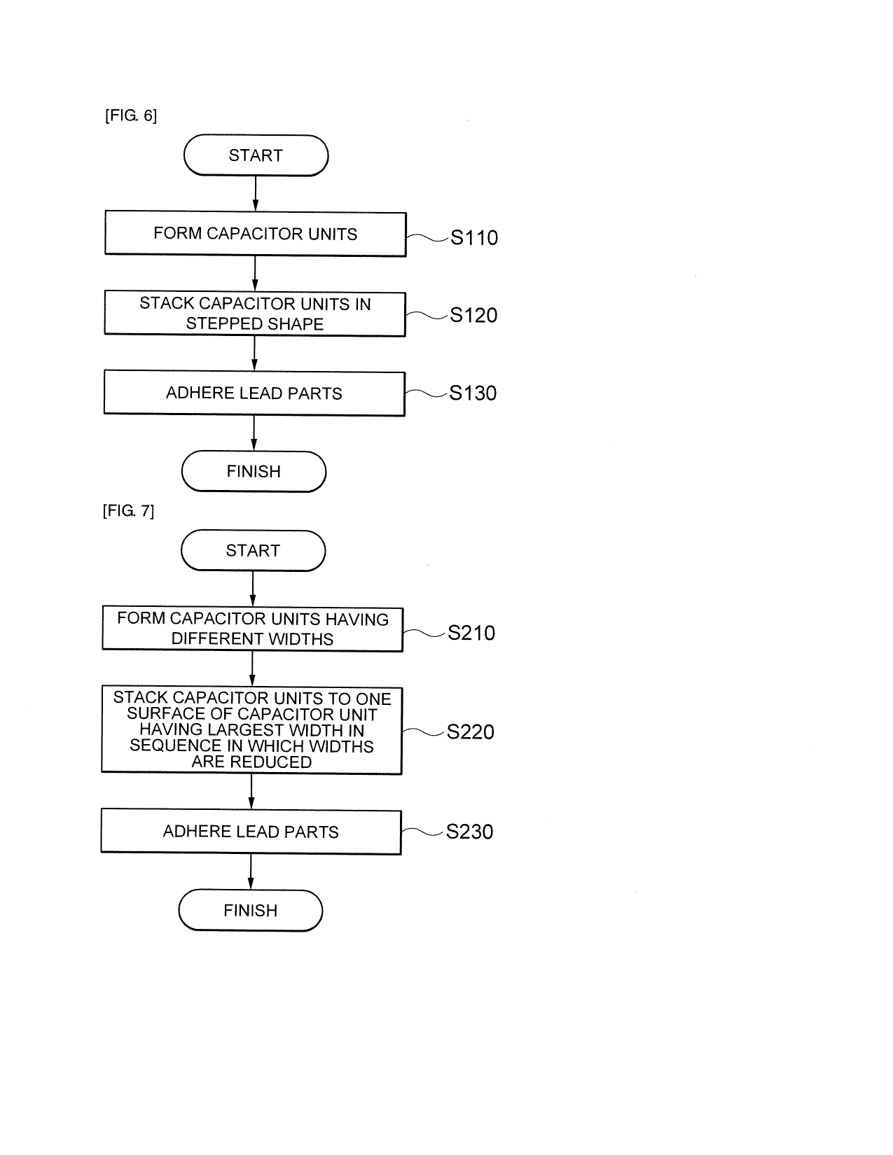

FIG. 6 is a flowchart schematically showing a method of manufacturing a capacitor in accordance with an exemplary embodiment of the present invention, and a FIG. 7 is a flowchart schematically showing a method of manufacturing a capacitor in accordance with another exemplary embodiment of the present invention.

Referring to FIGS. 6 and 7, the method of manufacturing a capacitor in accordance with an exemplary embodiment of the present invention may include forming capacitor units U (S110), stacking the capacitor units U (S120), and adhering collector lead parts 110′. Here, the method may include forming capacitor units having different widths (S210), and stacking the capacitor units to one surface or both surfaces on the capacitor unit having a largest width in a sequence in which the widths are gradually reduced (S220).

The capacitor units may have the same widths or different widths.

When the capacitor units have the same width, the capacitor 100 having the shape shown in FIG. 3 may be manufactured. In addition, when the capacitor units have different units, the capacitor 200 having the shape shown in FIG. 4 may be manufactured.

While stacking the capacitor units U may be slightly different according to kinds of the capacitors 100, 200 and 300 in accordance with the above-mentioned embodiments, it will be commonly applied that the adjacent capacitor units must have different polarities, may be stacked upward or downward in a stepped shape, or may be stacked upward and downward in a stepped shape.

As can be seen from the foregoing, since a capacitor and a method of manufacturing the same in accordance with an exemplary embodiment of the present invention have no necessity of separately providing lead portions configured to connect collectors to couple the collectors, a manufacturing efficiency can be improved. Simultaneously, since a degree of fatigue applied to a collector lead part is reduced in comparison with a conventional art, reliability can be improved and high capacity characteristics can be maintained for a relatively long time.

Embodiments of the invention have been discussed above with reference to the Figures. However, those skilled in the art will readily appreciate that the detailed description given herein with respect to these figures is for explanatory purposes as the invention extends beyond these limited embodiments. For example, it should be appreciated that those skilled in the art will, in light of the teachings of the present invention, recognize a multiplicity of alternate and suitable approaches, depending upon the needs of the particular application, to implement the functionality of any given detail described herein, beyond the particular implementation choices in the following embodiments described and shown. That is, there are numerous modifications and variations of the invention that are too numerous to be listed but that all fit within the scope of the invention.

What is claimed is:

1. A capacitor formed by stacking a plurality of capacitor units in which a positive or negative electrode material is applied to one surface or both surfaces of a collector and a separating film is provided on an outer surface of the electrode material, comprising:
a collector lead part projecting from the collector to the outside of the electrode material;
a first capacitor unit including a positive electrode material; and
a second capacitor unit including a negative electrode material,
wherein the first capacitor unit and the second capacitor unit are alternately stacked to three layers or more to form a stacked body,
collector lead parts of the first capacitor units are connected to contact each other,
collector lead parts of the second capacitor units are connected to contact each other, and
the collector lead parts of the stacked body are stacked such that projected side surfaces form a stepped shape.

2. The capacitor according to claim 1, wherein a width of the collector lead part in a direction projecting from the first capacitor unit is the same as a width of the collector lead part in a direction projecting from the second capacitor unit.

3. The capacitor according to claim 1, wherein the first capacitor unit or the second capacitor unit disposed at the uppermost layer of the stacked body has a largest width, and
a width of the second capacitor unit or the first capacitor unit is sequentially reduced downward from the uppermost layer of the stacked body.

4. The capacitor according to claim 1, wherein the separating films of the first capacitor unit and the second capacitor unit project to the outside of the positive electrode material or the negative electrode material.

5. A capacitor formed by stacking a plurality of capacitor units in which a positive or negative electrode material is applied to one surface or both surfaces of a collector and a separating film is provided on an outer surface of the electrode material, comprising:
a collector lead part projecting from the collector to the outside of the electrode material;
a first capacitor unit including a positive electrode material; and
a second capacitor unit including a negative electrode material,
wherein a stacked body is constituted by a first stage capacitor unit, which is any one capacitor unit selected from the first capacitor unit or the second capacitor unit, second stage capacitor units stacked on both surfaces of the first stage capacitor unit and having a width smaller than that of the first stage capacitor unit, and third stage capacitor units stacked on outer surfaces of the second stage capacitor units and having a width smaller than that of the second stage capacitor units.

6. The capacitor according to claim 5, wherein the first stage capacitor unit and the third stage capacitor unit comprise an electrode material having the same polarity, and
the second stage capacitor unit and the first stage capacitor unit comprise an electrode material having different polarities.

7. The capacitor according to claim 6, wherein the collector lead parts of the third stage capacitor units are bent toward the collector lead part of the first stage capacitor unit to electrically connect the collector lead parts.

8. The capacitor according to claim 6, wherein the collector lead parts of the second stage capacitor unit are bent toward the first stage capacitor unit to be electrically connected to each other.

9. The capacitor according to claim 5, wherein the stacked body further comprises capacitor units having widths that are reduced in a direction far away from the outer surfaces of the third stage capacitor units.

10. The capacitor according to claim 5, wherein the separating film of the capacitor unit projects to the outside of the electrode material.

11. A capacitor formed by stacking a plurality of capacitor units in which a positive or negative electrode material is applied to one surface or both surfaces of a collector and a separating film is provided on an outer surface of the electrode material, comprising:
a collector lead part projecting from the collector to the outside of the electrode material;
a first capacitor unit including a positive electrode material; and
a second capacitor unit including a negative electrode material,
wherein a first stacked body unit cell is constituted by a first stage capacitor unit, which is any one capacitor unit selected from the first capacitor unit or the second capacitor unit, second stage capacitor units stacked on both surfaces of the first stage capacitor unit and having a width smaller than that of the first stage capacitor unit, and third stage capacitor units stacked on outer surfaces of the second stage capacitor units and having a width smaller than that of the second stage capacitor units, and
a second stacked body unit cell is formed by the same manner as the first stacked body unit cell and coupled to the outer surface of the first stacked body unit cell.

12. The capacitor according to claim 11, wherein the first stage capacitor unit and the third stage capacitor unit comprise an electrode material having the same polarity, and
the second stage capacitor unit and the first stage capacitor unit comprise an electrode material having different polarities.

13. The capacitor according to claim 12, wherein the collector lead parts of the third stage capacitor units are bent toward the collector lead part of the first stage capacitor unit to electrically connect the collector lead parts.

14. The capacitor according to claim 12, wherein the collector lead parts of the second stage capacitor unit are bent toward the first stage capacitor unit to be electrically connected to each other.

15. The capacitor according to claim 11, wherein the first stacked body unit cell further comprises capacitor units having widths that are sequentially reduced in a direction far away from the outer surface of the third stage capacitor unit.

16. A method of manufacturing a capacitor including a positive or negative electrode material, a separating film provided on an outer surface of the electrode material, a first capacitor unit in which the positive electrode material is coupled to one surface or both surfaces of a collector, a second capacitor unit in which the negative electrode material is coupled to one surface or both surfaces of a collector, and a collector lead part projecting from the collector to the outside of the electrode material, comprising:
forming the first capacitor unit and the second capacitor unit;
alternately stacking the first capacitor unit and second capacitor unit to three layers or more, wherein the collector lead parts are stacked in a stepped shape in a projecting direction; and
bending and adhering the collector lead parts of the first capacitor units to contact each other, and bending and adhering the collector lead parts of the second capacitor units to contact each other.

17. The method of manufacturing a capacitor according to claim 16, wherein forming the first capacitor unit and the second capacitor unit such that a width of the collecting lead part in a direction projecting from the first capacitor unit is equal to a width of the collector lead part in a direction projecting from the second capacitor unit.

18. The method of manufacturing a capacitor according to claim 16, wherein forming the first capacitor unit and the second capacitor unit such that a width of the collecting lead part in a direction projecting from the first capacitor unit is different from a width of the collector lead part in a direction projecting from the second capacitor unit.

19. A method of manufacturing a capacitor including a positive or negative electrode material, a separating film provided on an outer surface of the electrode material, a first capacitor unit in which the positive electrode material is coupled to one surface or both surfaces of a collector, a second capacitor unit in which the negative electrode material is coupled to one surface or both surfaces of a collector, and a collector lead part projecting from the collector to the outside of the electrode material, comprising:
forming capacitor units including the first capacitor units and the second capacitor units, wherein the capacitor units have different widths;
stacking the capacitor units on one surface or both surfaces of the capacitor unit having a largest width in a sequence in which the widths are gradually reduced, wherein the first capacitor units and the second capacitor units are alternately stacked; and
bending and adhering the collector lead parts of the first capacitor units to contact each other, and bending and adhering the collector lead parts of the second capacitor units to contact each other.
